(19) United States
(12) Patent Application Publication
(10) Pub. No.: US 2018/0109953 A1
(43) Pub. Date: Apr. 19, 2018

(54) Method, Apparatus, and System for Preventing Diameter Signaling Attack in Wireless Network

(71) Applicant: Huawei Technologies Co., Ltd., Shenzhen (CN)

(72) Inventor: Chengdong He, Shenzhen (CN)

(21) Appl. No.: 15/847,094

(22) Filed: Dec. 19, 2017

Related U.S. Application Data
(63) Continuation of application No. PCT/CN2016/072652, filed on Jan. 29, 2016.

(30) Foreign Application Priority Data
Jun. 19, 2015 (CN) 201510344865.4

(51) Int. Cl. H04W 12/06

(52) U.S. Cl. CPC H04W 12/06; H04L 63/1441

(57) ABSTRACT

A method includes receiving a diameter request message sent by a home subscriber server HSS, where the diameter request message carries a source domain name and a user identity, and determining whether a binding relationship between the source domain name and the user identity is correct. If the binding relationship is incorrect, the method includes discarding the diameter request message or sending a diameter response message to the HSS, where the diameter response message carries a failure code. In the embodiments of the present application, when the binding relationship between the source domain name and the user identity that are carried in the diameter request message is incorrect, the diameter request message is discarded or the diameter response message carrying the failure code is sent.

### CROSS-REFERENCE TO RELATED APPLICATIONS

This application is a continuation of International Application No. PCT/CN2016/072652, filed on Jan. 29, 2016, which claims priority to Chinese Patent No. 201510344865.4, filed on Jun. 19, 2015. The disclosures of the aforementioned applications are hereby incorporated by reference in their entireties.

### TECHNICAL FIELD

The present application relates to the communications field, and in particular, to a method, an apparatus, and a system for preventing a Diameter signaling attack in a wireless network.

### BACKGROUND

When a user accesses a network, a scenario in which a Mobile Management Entity (MME) or a serving General Packet Radio Service (GPRS) support node (SGSN for short) that provides a service for the user, and a Home Subscriber Server (HSS) of the user, belong to a same operator is referred to as a non-roaming scenario for the user. When a user accesses a network, a scenario in which an MME or an SGSN that provides a service for the user, or an HSS of the user, belong to different operators is referred to as a roaming scenario for the user.

In a 4th Generation Mobile Communication System (4G) network, when an MME or an SGSN and an HSS belong to a same operator, all network elements on two sides of an S6a or S6d interface can be controlled by the operator, and therefore, there is no security risk.

However, when the MME or the SGSN and the HSS belong to different operators, for example, the MME or the SGSN belongs to an operator A, and the HSS belongs to an operator B that signs a roaming agreement with the operator A, the following security threats exist.

The operator B may open a network capability of the operator B to a third party, and the third party may launch an attack on an MME or an SGSN of the operator A by using an HSS of the operator B. In another example, a malicious person inside the operator B may directly launch the following attacks on an MME or an SGSN of the operator A by using an HSS of the operator B.

In other case, a cancel location request message is forged to instruct the MME or the SGSN to revoke a subscription of a valid user of the operator A, or because a new MME location update process has occurred and the MME has been cancelled, resulting in network detachment of the valid user. Such an attack may be referred to as a Denial Of Service (DOS) attack. In another case, an insert subscriber data request message or a delete subscriber data request message is forged to instruct the MME or the SGSN to modify or delete saved subscription data of a valid user of the operator A (for example, by increasing or decreasing subscribed bandwidth charged at a monthly flat fee), resulting in a billing discrepancy. In another case, a Reset Request message is forged to instruct the MME or the SGSN to perform the following: because the HSS is restarted, an identifier of the MME or the SGSN that is currently serving some users of the operator A is lost, so that the MME or the SGSN launches a recovery procedure for these affected users, thereby increasing a processing load on the MME or the SGSN. This may be referred to as a DoS attack.

According to the 3rd Generation Partnership Project (3GPP for short) standard TS 33.210, Internet Protocol Security (IPSEC for short) may be deployed on the S6a/S6d interface, to ensure S6a/S6d interface security, for example, identity authentication between the MME or the SGSN and the HSS, and data integrity and confidentiality over an IP layer. However, because the foregoing attacks belong to attacks in terms of diameter signaling over the IP layer, even if identity authentication between the MME or the SGSN and the HSS succeeds and data integrity and confidentiality over the IP layer is ensured, an attacker may still send diameter signaling to launch an attack. This greatly affects network security performance.

### SUMMARY

Embodiments of the present application provide a method, an apparatus, and a system for preventing a diameter signaling attack in a wireless network, so as to prevent a diameter signaling attack, and further improve network security performance.

According to a first aspect, a method for preventing a diameter signaling attack in a wireless network is provided. The method includes receiving, by a mobile management entity (MME), a serving general packet radio service support node (SGSN), or a diameter agent, a diameter request message sent by a home subscriber server (HSS), where the diameter request message carries a source domain name and a user identity. The method also includes determining whether a first binding relationship between the source domain name and the user identity is correct. The method also includes, if the first binding relationship is incorrect, discarding the diameter request message, or sending a diameter response message to the HSS, where the diameter response message carries a failure code.

With reference to the first aspect, in a first possible implementation, the method further includes: if the first binding relationship is correct, determining, according to the diameter request message, whether a diameter relay agent (DRA) exists between the MME, the SGSN, or the diameter agent, and the HSS. The method also includes, if the DRA exists between the MME, the SGSN, or the diameter agent, and the HSS, continuing to perform service processing.

With reference to the first possible implementation, in a second possible implementation, the diameter request message further carries a source IP address. In this case, the method further includes, if the DRA does not exist between the MME, the SGSN, or the diameter agent, and the HSS, determining whether a second binding relationship between the source IP address and the source domain name and/or a source host name is correct. The method also includes, if the second binding relationship is incorrect, discarding the diameter request message or sending a diameter response message to the HSS, where the diameter response message carries a failure code, or if the second binding relationship is correct, continuing to perform service processing.

With reference to the first possible implementation, in a third possible implementation, the method further includes, if the DRA does not exist between the MME or the SGSN or the diameter agent and the HSS, continuing to perform service processing.

With reference to the first possible implementation, in a fourth possible implementation, the diameter request message further carries a source IP address. In this case, if the DRA exists between the diameter agent and the HSS, continuing to perform service processing includes: if the DRA exists between the diameter agent and the HSS, determining whether the source domain name is consistent with a domain name of the diameter agent; if the source domain name is consistent with the domain name of the diameter agent, determining whether the source IP address belongs to an IP network segment of a network to which the diameter agent belongs; and if the source IP address does not belong to the IP network segment, discarding the diameter request message or sending a diameter response message to the HSS, where the diameter response message carries a failure code; or if the source IP address belongs to the IP network segment, continuing to perform service processing.

With reference to any possible implementation of the first to the fourth possible implementations, in a fifth possible implementation, the determining, according to the diameter request message, whether a diameter relay agent DRA exists between the MME or the SGSN or the diameter agent and the HSS includes: if the diameter request message does not carry a route record parameter, determining that the DRA does not exist between the MME or the SGSN or the diameter agent and the HSS; or if the diameter request message carries a route record parameter, determining that the DRA exists between the MME or the SGSN or the diameter agent and the HSS.

With reference to the first aspect or any one of the foregoing possible implementations, in a sixth possible implementation, the failure code indicates that continuing to process the diameter request message is rejected or not allowed.

With reference to the first aspect or any one of the foregoing possible implementations, in a seventh possible implementation, the diameter request message is any one of the following: a cancel location request message, an insert subscriber data request message, a delete subscriber data request message, or a reset request message.

With reference to the first aspect or any possible implementation of the first to the sixth possible implementations, in an eighth possible implementation, the diameter response message is any one of the following: a cancel location response message, an insert subscriber data response message, a delete subscriber data response message, or a reset response message.

With reference to any possible implementation of the first to the third possible implementations, in a ninth possible implementation, if the diameter request message is a cancel location request message, and a cancel type parameter carried in the cancel location request message represents an MME update process or an SGSN update process, that the MME or the SGSN continues to perform service processing includes: determining whether a context request message or an identification request message is received; and when the context request message or the identification request message is not received, discarding the diameter request message or sending a diameter response message to the HSS, where the diameter response message carries a failure code; or when the context request message or the identification request message is received, continuing to perform service processing.

With reference to the first aspect or any possible implementation of the first to the sixth possible implementations, in a tenth possible implementation, when the diameter request message is a reset request message, the user identity is a user identity list, and the determining whether a first binding relationship between the source domain name and the user identity is correct includes: determining whether first binding relationships between the source domain name and all user identities in the user identity list are correct.

According to a second aspect, an apparatus for preventing a diameter signaling attack in a wireless network is provided. The apparatus includes a transceiver unit, configured to receive a diameter request message sent by a home subscriber server (HSS), where the diameter request message carries a source domain name and a user identity. The apparatus also includes a processing unit, configured to determine whether a first binding relationship between the source domain name and the user identity is correct. The processing unit is further configured to, if the first binding relationship is incorrect, discard the diameter request message, or the transceiver unit is further configured to, if the first binding relationship is incorrect, send a diameter response message to the HSS, where the diameter response message carries a failure code.

With reference to the second aspect, in a first possible implementation of the second aspect, the processing unit is further configured to: if the first binding relationship is correct, determine, according to the diameter request message, whether a diameter relay agent DRA exists between the apparatus and the HSS; and if the DRA exists between the apparatus and the HSS, continue to perform service processing.

With reference to the first possible implementation of the second aspect, in a second possible implementation of the second aspect, the diameter request message further carries a source IP address, the processing unit is further configured to: if the DRA does not exist between the apparatus and the HSS, determine whether a second binding relationship between the source IP address and the source domain name and/or a source host name is correct; and if the second binding relationship is correct, continue to perform service processing; or if the second binding relationship is incorrect, discard the diameter request message; or the transceiver unit is further configured to: if the second binding relationship is incorrect, send a diameter response message to the HSS, where the diameter response message carries a failure code.

With reference to the first possible implementation of the second aspect, in a third possible implementation of the second aspect, if the DRA does not exist between the apparatus and the HSS, service processing continues to be performed.

With reference to the first possible implementation of the second aspect, in a fourth possible implementation of the second aspect, the apparatus is a diameter agent, the diameter request message further carries a source IP address, and the processing unit is specifically configured to: if the DRA exists between the diameter agent and the HSS, determine whether the source domain name is consistent with a domain name of the diameter agent; if the source domain name is consistent with the domain name of the diameter agent, determine whether the source IP address belongs to an IP network segment of a network to which the diameter agent belongs; and if the source IP address belongs to the IP network segment, continue to perform service processing; or if the source IP address does not belong to the IP network segment, discard the diameter request message; or the transceiver unit is further configured to: if the source IP address does not belong to the IP network segment, send a diameter response message to the HSS, where the diameter response message carries a failure code.

With reference to any possible implementation of the first to the fourth possible implementations of the second aspect, in a fifth possible implementation of the second aspect, the processing unit is configured to: if the diameter request message does not carry a route record parameter, determine that the DRA does not exist between the apparatus and the HSS; or if the diameter request message carries a route record parameter, determine that the DRA exists between the apparatus and the HSS.

With reference to the second aspect or any one of the foregoing possible implementations of the second aspect, in a sixth possible implementation of the second aspect, the failure code indicates that continuing to process the diameter request message is rejected or not allowed.

With reference to the second aspect or any one of the foregoing possible implementations of the second aspect, in a seventh possible implementation of the second aspect, the diameter request message is any one of the following: a cancel location request message, an insert subscriber data request message, a delete subscriber data request message, or a reset request message.

With reference to the second aspect or any possible implementation of the first to the sixth possible implementations of the second aspect, in an eighth possible implementation of the second aspect, the diameter response message is any one of the following: a cancel location response message, an insert subscriber data response message, a delete subscriber data response message, or a reset response message.

According to a third aspect, a mobile management entity (MME), a serving general packet radio service support node (SGSN), or a diameter agent that has a function of preventing a diameter signaling attack in a wireless network, is provided. The MME, the SGSN, or the diameter agent that is provided includes a transceiver, configured to receive a diameter request message sent by a home subscriber server (HSS), where the diameter request message carries a source domain name and a user identity. The MME, the SGSN, or the diameter agent that is provided also includes a processor, configured to determine whether a first binding relationship between the source domain name and the user identity is correct. The processor is further configured to: if the first binding relationship is incorrect, discard the diameter request message; or the transceiver is further configured to: if the processor determines that the first binding relationship is incorrect, send a diameter response message to the HSS, where the diameter response message carries a failure code.

With reference to the third aspect, in a first possible implementation of the third aspect, the processor is further configured to: if the first binding relationship is correct, determine, according to the diameter request message, whether a diameter relay agent DRA exists between the MME or the SGSN or the diameter agent and the HSS; and if the DRA exists between the MME or the SGSN or the diameter agent and the HSS, continue to perform service processing.

With reference to the first possible implementation of the third aspect, in a second possible implementation of the third aspect, the diameter request message further carries a source IP address, and the processor is further configured to: if the DRA does not exist between the MME or the SGSN or the diameter agent and the HSS, determine whether a second binding relationship between the source IP address and the source domain name and/or a source host name is correct; and if the second binding relationship is correct, continue to perform service processing; or if the second binding relationship is incorrect, discard the diameter request message; or the transceiver is further configured to: if the second binding relationship is incorrect, send a diameter response message to the HSS, where the diameter response message carries a failure code.

With reference to the first possible implementation of the third aspect, in a third possible implementation of the third aspect, the diameter request message further carries a source IP address, and the processor is specifically configured to: if the DRA exists between the diameter agent and the HSS, determine whether the source domain name is consistent with a domain name of the diameter agent; if the source domain name is consistent with the domain name of the diameter agent, determine whether the source IP address belongs to an IP network segment of a network to which the diameter agent belongs; and if the source IP address belongs to the IP network segment, continue to perform service processing; or if the source IP address does not belong to the IP network segment, discard the diameter request message; or the transceiver is further configured to: if the source IP address does not belong to the IP network segment, send a diameter response message to the HSS, where the diameter response message carries a failure code.

With reference to the third aspect or any one of the foregoing possible implementations of the third aspect, in a fourth possible implementation of the third aspect, the failure code indicates that continuing to process the diameter request message is rejected or not allowed.

According to a fourth aspect, a system for preventing a diameter signaling attack in a wireless network is provided, including a mobile management entity (MME, a serving general packet radio service support node (SGSN), or a diameter agent, and a home subscriber server (HSS). The HSS is configured to send a diameter request message to the MME or the SGSN or the diameter agent, where the diameter request message carries a source domain name and a user identity. The MME or the SGSN or the diameter agent is configured to: receive the diameter request message, determine whether a first binding relationship between the source domain name and the user identity that are carried in the diameter request message is correct, and, if the first binding relationship is incorrect, discard the diameter request message or send a diameter response message to the HSS, where the diameter response message carries a failure code.

With reference to the fourth aspect, in a first possible implementation of the fourth aspect, the MME or the SGSN or the diameter agent is further configured to: if the first binding relationship is correct, determine, according to the diameter request message, whether a diameter relay agent DRA exists between the MME or the SGSN or the diameter agent and the HSS; and if the DRA exists between the MME or the SGSN or the diameter agent and the HSS, continue to perform service processing.

With reference to the first possible implementation of the fourth aspect, in a second possible implementation of the fourth aspect, the diameter request message further carries a source IP address, the MME or the SGSN or the diameter agent is further configured to: if the DRA does not exist between the MME or the SGSN or the diameter agent and the HSS, determine whether a second binding relationship between the source IP address and the source domain name and/or a source host name is correct; and if the second binding relationship is incorrect, discard the diameter request message or send a diameter response message to the HSS, where the diameter response message carries a failure code; or if the second binding relationship is correct, continue to perform service processing.

With reference to the first possible implementation of the fourth aspect, in a third possible implementation of the fourth aspect, the diameter request message further carries a source IP address, and the diameter agent is specifically configured to: if the DRA exists between the diameter agent and the HSS, determine whether the source domain name is consistent with a domain name of the diameter agent; if the source domain name is consistent with the domain name of the diameter agent, determine whether the source IP address belongs to an IP network segment of a network to which the diameter agent belongs; and if the source IP address does not belong to the IP network segment, discard the diameter request message or send a diameter response message to the HSS, where the diameter response message carries a failure code; or if the source IP address belongs to the IP network segment, continue to perform service processing.

With reference to the fourth aspect or any one of the foregoing possible implementations of the fourth aspect, in a fourth possible implementation of the fourth aspect, the failure code indicates that continuing to process the diameter request message is rejected or not allowed.

Based on the foregoing technical solutions, it is determined whether a binding relationship between a source domain name and a user identity that are carried in a diameter request message is correct, and if the binding relationship is incorrect, the diameter request message is discarded or a diameter response message carrying a failure code is sent. In this manner, a diameter signaling attack can be prevented, and network security performance can be further improved.

### BRIEF DESCRIPTION OF THE DRAWINGS

To describe the technical solutions in the embodiments of the present application more clearly, the following briefly describes the accompanying drawings required for describing the embodiments of the present application. Apparently, the accompanying drawings in the following description show merely some embodiments of the present application, and a person of ordinary skill in the art may still derive other drawings from these accompanying drawings without creative efforts.

FIG. 1 is a schematic diagram of a network attack in a roaming scenario in accordance with an embodiment;

FIG. 2 is a schematic flowchart of a method for preventing a diameter signaling attack in a wireless network according to an embodiment of the present application;

FIG. 3 is a schematic flowchart of a method for preventing a diameter signaling attack in a wireless network according to another embodiment of the present application;

FIG. 4 is a schematic block diagram of an apparatus for preventing a diameter signaling attack in a wireless network according to an embodiment of the present application; and

FIG. 5 is a schematic block diagram of an apparatus for preventing a diameter signaling attack in a wireless network according to another embodiment of the present application.

### DETAILED DESCRIPTION OF ILLUSTRATIVE EMBODIMENTS

The following describes the technical solutions in the embodiments of the present application with reference to the accompanying drawings in the embodiments of the present application. Apparently, the described embodiments are a part rather than all of the embodiments of the present application. All other embodiments obtained by a person of ordinary skill in the art based on the embodiments of the present application without creative efforts shall fall within the protection scope of the present application.

In the specification, claims, and accompanying drawings of this application, the terms “first”, “second”, “third”, and the like are intended to distinguish between different objects but do not indicate a particular order. In addition, the terms “include” and “have” are not exclusive. For example, a process, a method, a system, a product, or a device including a series of steps or units is not limited to the listed steps or units, and may further include steps or units that are not listed.

The following describes several possible attack modes with reference to FIG. 1.

As shown in FIG. 1, a network may include an HSS 1, an HSS 2, and an HSS 3 that respectively correspond to operators A, B, and C. Both an MME and the HSS1 belong to the operator A. As an illustrative example, an attacker may launch an attack on the HSS 2 side. The attack may follow one or more of the following attack modes.
(1) In an attack mode 1, a source domain name or a host name and an International Mobile Subscriber Identity (IMSI) belong to different operators. An attacker directly uses a domain name or a host name of the HSS 2 in attack signaling, but an IMSI belongs to another HSS (for example, the HSS 1 or the HSS 3).
(2) In an attack mode 2, a source domain name or a host name and an IMSI belong to different operators. Generally, because an attacker may deduce, according to a country code and a network code in an IMSI, a domain name or a host name of an HSS (for example, the HSS i) to which the IMSI belongs, the attacker may directly forge a domain name or a host name of another HSS (for example, the HSS 3) in attack signaling, but an IMSI belongs to another HSS (for example, the HSS 1).
(3) In an attack mode 3, a source domain name or a host name and an IMSI belong to a same operator. An attacker may directly forge a domain name or a host name of another HSS (for example, the HSS 1) in attack signaling, an IMSI may also belong to the HSS 1, and in this case, an operator corresponding to the HSS 1 and an operator to which the MME belongs are a same operator.
(4) In an attack mode 4, a domain name or a host name and an IMSI belong to a same operator. An attacker may directly forge a domain name or a host name of another HSS (for example, the HSS 3) in attack signaling, and an IMSI may also belong to the HSS 3.

In actual networking, to improve performance, one or more diameter agents may be deployed between an HSS and an MME (or an SGSN). There are two types of diameter agents: a diameter edge agent (DEA for short) and a diameter relay agent (DRA for short). For example, the DEA may be usually deployed on a network border of an operator, and is used for equipment interconnection to another operator. As shown in FIG. 1, there are usually two DEAs, and the two DEAs (for example, a DEA 1 and a DEA 2) work in a load sharing manner. It should be understood that, FIG. 1 is only an example, and the DEA may have functions of both the DEA and the DRA.

It should be noted that, in FIG. 1, only DEA or DRA networking inside the operator A is used as an example for description, and networking inside the operators B and C are similar, that is, a DEA is deployed on a border of each operator.

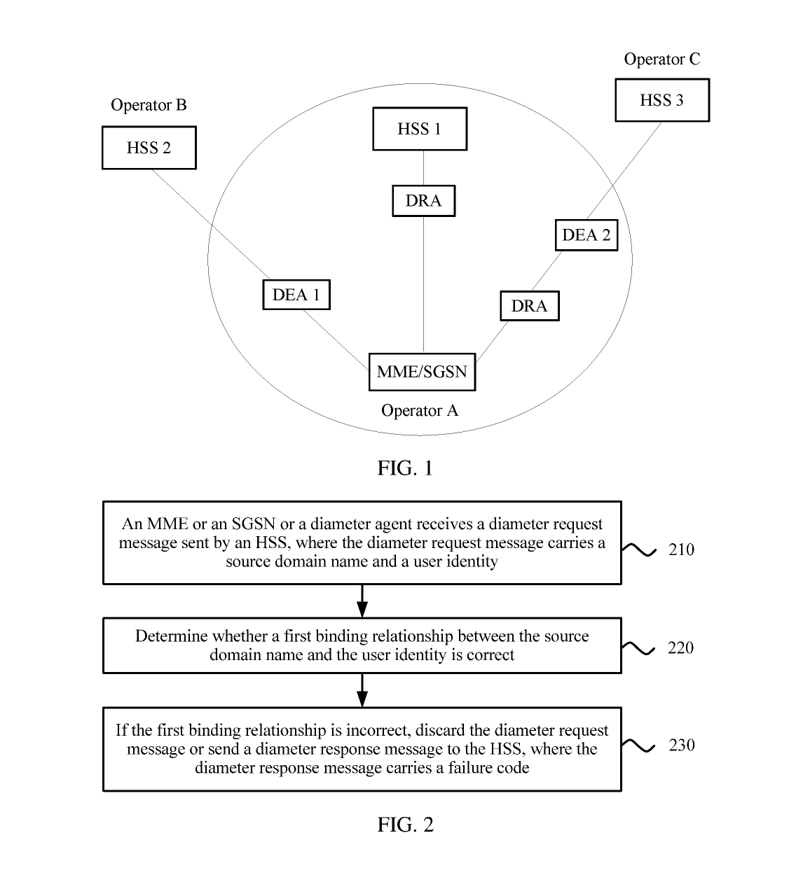

FIG. 2 is a schematic flowchart of a method 200 for preventing a diameter signaling attack in a wireless network according to an embodiment of the present application. The method 200 may be executed by an MME or an SGSN. When a diameter agent exists between the MME or the SGSN and an HSS, as shown in FIG. 1, a diameter request message sent by the HSS first arrives at the diameter agent. In this case, the method 200 may be executed by the diameter agent. For ease of description, the following uses a DEA as an example for description.

As shown in FIG. 2, the method 200 includes the following steps. 210. Receive a diameter request message sent by a home subscriber server (HSS), where the diameter request message carries a source domain name and a user identity.

The diameter request message may be any one of the following: a cancel location request message, an insert subscriber data request message, a delete subscriber data request message, or a reset request message. For the reset request message, the user identity carried in the diameter request message is a user identity list (user ID list), and the user identity list includes one or more user identities.

It should be understood that, the diameter request message may further carry other information, such as a source host name, a destination domain name, a destination host name, and a source IP address.

The user identity is an International Mobile Subscriber Identity Number (IMSI).

220. Determine whether a first binding relationship between the source domain name and the user identity is correct.

230. If the first binding relationship is incorrect, discard the diameter request message or send a diameter response message to the HSS, where the diameter response message carries a failure code.

In this embodiment of the present application, it is determined whether a binding relationship between a source domain name and a user identity that are carried in a diameter request message is correct, and if the binding relationship is incorrect, the diameter request message is discarded or a diameter response message carrying a failure code is sent. As such, a diameter signaling attack can be prevented, and network security performance can be further improved.

In this embodiment of the present application, attacks in the attack mode 1 and the attack mode 2 may be effectively prevented.

In step 220, it may be determined, according to multiple methods, whether the first binding relationship between the source domain name and the user identity that are carried in the diameter request message is correct.

For example, after receiving a location update response (ULA) message of the HSS in a user equipment (UE) attach process or a tracking area update (TAU) process, the MME or the SGSN or the DEA saves a correct binding relationship between a source domain name (origin-realm) in the ULA and a user identity in a location update request (ULR) message. The presaved correct binding relationship is compared with the first binding relationship to determine whether the first binding relationship between the user identity and the source domain name that are carried in the diameter request message is correct.

Alternatively, when the user identity is an IMSI, the MME or the SGSN or the DEA may determine, according to the IMSI, a correct source domain name bound to the IMSI. For example, an IMSI of a user is 460 88 0755088888, a country code herein is 460, and a network code is 88. Therefore, according to a definition of a domain name in the 3GPP standard, the MME or the SGSN or the DEA may deduce that a domain name of an HSS corresponding to the IMSI is epc.mnc88.mcc460.3gppnetwork.org. Further, it may be determined whether the first binding relationship between the user identity and the source domain name that are carried in the diameter request message is correct.

Alternatively, a correct binding relationship between an IMSI and a source domain name (origin-realm) of an HSS to which the IMSI belongs may be preconfigured. The preconfigured correct binding relationship is compared with the first binding relationship to determine whether the first binding relationship between the user identity and the source domain name that are carried in the diameter request message is correct.

It should be understood that, optionally, in step 220, it may be further determined whether a first binding relationship between (the source domain name, the source host name) and the user identity that are carried in the diameter request message, is correct. A method is similar to that described above, and details are not repeatedly described herein.

For the reset request message, step 220 includes: determining whether first binding relationships between the source domain name and all user identities in the user identity list are correct. Correspondingly, when the binding relationships between the source domain name and all the user identities in the user identity list are correct, it is determined that the first binding relationship is correct; or when a binding relationship between the source domain name and any user identity in the user identity list is incorrect, it is determined that the first binding relationship is incorrect.

For example, it may be determined whether a first binding relationship between the source domain name carried in the diameter request message and each user identity in the user identity list is correct.

Optionally, in another embodiment, the method 200 further includes: if the first binding relationship is correct, continuing to perform service processing.

Optionally, in another embodiment, the method 200 further includes: if the first binding relationship is correct, determining, according to the diameter request message, whether a diameter relay agent DRA exists between the MME or the SGSN or the DEA and the HSS. If the DRA exists between the MME or the SGSN or the DEA and the HSS, the method 200 further includes continuing to perform service processing.

Optionally, in another embodiment, the diameter request message further carries a source IP address, and the method 200 further includes if the first binding relationship is correct and the DRA does not exist between the MME or the SGSN or the DEA and the HSS, determining whether a second binding relationship between the IP address and the source domain name and/or the source host name is correct. If the second binding relationship is correct, the method 200 also includes continuing to perform service processing, or if the second binding relationship is incorrect, the method 200 includes discarding the diameter request message or sending a diameter response message to the HSS, where the diameter response message carries a failure code.

It should be understood that, optionally, if the first binding relationship is correct and the DRA does not exist between the MME or the SGSN or the DEA and the HSS, service processing may continue to be performed. If the DRA does not exist between the MME or the SGSN or the DEA and the HSS, it may be considered that the MME or the SGSN or the DEA and the HSS belong to a same operator. Therefore, the MME or the SGSN or the DEA and the HSS may continue to perform service processing.

Specifically, the determining, according to the diameter request message, whether a diameter relay agent DRA exists between the MME or the SGSN or the DEA and the HSS includes: if the diameter request message does not carry a route record parameter, determining that the DRA does not exist between the MME or the SGSN or the DEA and the HSS; or if the diameter request message carries a route record parameter, determining that the DRA exists between the MME or the SGSN or the DEA and the HSS.

Because the DRA adds the route record parameter to the diameter request message, according to whether the diameter request message carries the route record parameter, it may be determined whether the DRA exists between the MME or the SGSN or the DEA and the HSS. The route record parameter includes an identity, such as a source domain name and/or a source host name, of a previous-hop node.

Optionally, when the method 200 is executed by the MME or the SGSN, the continuing to perform service processing includes, if the diameter request message is a cancel location request, and a cancel type parameter carried in the diameter request message represents an (MME Update Procedure or an SGSN Update Procedure, determining whether a context request message or an identification request message is received. The continuing to perform service processing also includes, when the context request message or the identification request message is not received, discarding the diameter request message or sending a diameter response message to the HSS, where the diameter response message carries a failure code; or when the context request message or the identification request message is received, continuing to perform service processing.

Optionally, in another embodiment, if the method 200 is executed by the DEA, the diameter request message further carries a source IP address, and the DRA exists between the DEA and the HSS, the continuing to perform service processing includes: if the DRA exists between the DEA and the HSS, determining whether the source domain name is consistent with a domain name of the DEA; if the source domain name is consistent with the domain name of the DEA, determining whether the source IP address belongs to an IP network segment of a network to which the DEA belongs; and if the source IP address belongs to the IP network segment, continuing to perform service processing; or if the source IP address does not belong to the IP network segment, discarding the diameter request message or sending a diameter response message to the HSS, where the diameter response message carries a failure code.

In this embodiment of the present application, an attack in the attack mode 3 can be effectively prevented.

Optionally, in another embodiment, the method 200 is executed by the DEA, the diameter request message further carries a source IP address, and the continuing to perform service processing includes: if the first binding relationship is correct, and the DRA exists between the DEA and the HSS, determining whether the source domain name is consistent with a domain name of the DEA; and if the source domain name is not consistent with the domain name of the DEA, continuing to perform service processing.

As the attack mode 4 described above, an attacker may directly forge a domain name or a host name of an HSS of another operator and an IMSI of the another operator (that is, an IMSI of a victim) in attack signaling. Assuming the DEA belongs to the operator A shown in FIG. 1, an attacker forges a domain name and a host name of an HSS 3 of the operator C in attack signaling. Because the DEA does not belong to the operator C, when a message of the attacker arrives at the DEA, the DEA cannot detect whether a source IP address of an IP layer in a diameter request message belongs to an IP network segment of the operator C, and the diameter request message needs to be sent to the MME or the SGSN for further processing.

It should be noted that, in this attack mode, an attack succeeds only when the following conditions are met: a user (that is, a victim) of the HSS 3 corresponding to the IMSI just roams to a network of the operator A; and the roaming user is exactly served by the MME or the SGSN.

According to the foregoing analysis, it may be considered that if the source domain name is not consistent with the domain name of the DEA, a risk of continuing to perform service processing is very small.

Optionally, the diameter request message further carries the destination domain name. In this case, the method 200 further includes: determining whether the destination domain name is consistent with a domain name of the DEA; and if the destination domain name is not consistent with the domain name of the DEA, discarding the diameter request message or sending a diameter response message to the HSS, where the diameter response message carries a failure code.

It should be understood that, it may be further determined whether the destination host name carried in the diameter request message is consistent with a host name of the DEA.

Correspondingly, if the destination domain name is not consistent with the domain name of the DEA, or the destination host name is not consistent with the host name of the DEA, or (the destination domain name, the destination host name) is not consistent with (the domain name of the DEA, the host name of the DEA), the diameter request message is discarded or a diameter response message is sent to the HSS, where the diameter response message carries a failure code.

As used herein, (the destination domain name, the destination host name) represents a combination of the destination domain name and the destination host name, and similarly, (the domain name of the DEA, the host name of the DEA) represents a combination of the domain name of the DEA and the host name of the DEA.

The diameter response message in this embodiment of the present application may be a cancel location response (Cancel location answer), an insert subscriber data response (Insert Subscriber Data answer), a delete subscriber data response (Delete Subscriber Data answer), or a reset response (reset answer). When the diameter response message carries a failure code, the failure code is carried in a result parameter, and the failure code may represent rejecting or not allowing continuing to process the diameter request message, or may be another failure code.

It should be noted that, when the method 200 is executed by the DEA, the continuing to perform service processing means that the DEA sends the diameter request message to the MME or the SGSN. When the method 200 is executed by the MME or the SGSN, the continuing to perform service processing means that the diameter request message is further processed according to a conventional procedure. A further processing procedure is similar to a processing procedure in the prior art, and details are not described herein.

In this embodiment of the present application, it is determined whether a binding relationship between a source domain name and a user identity (or a user identity list) that are carried in a diameter request message is correct, and if the binding relationship is incorrect, the diameter request message is discarded or a diameter response message carrying a failure code is sent, so that a diameter signaling attack can be prevented, and network security performance can be further improved.

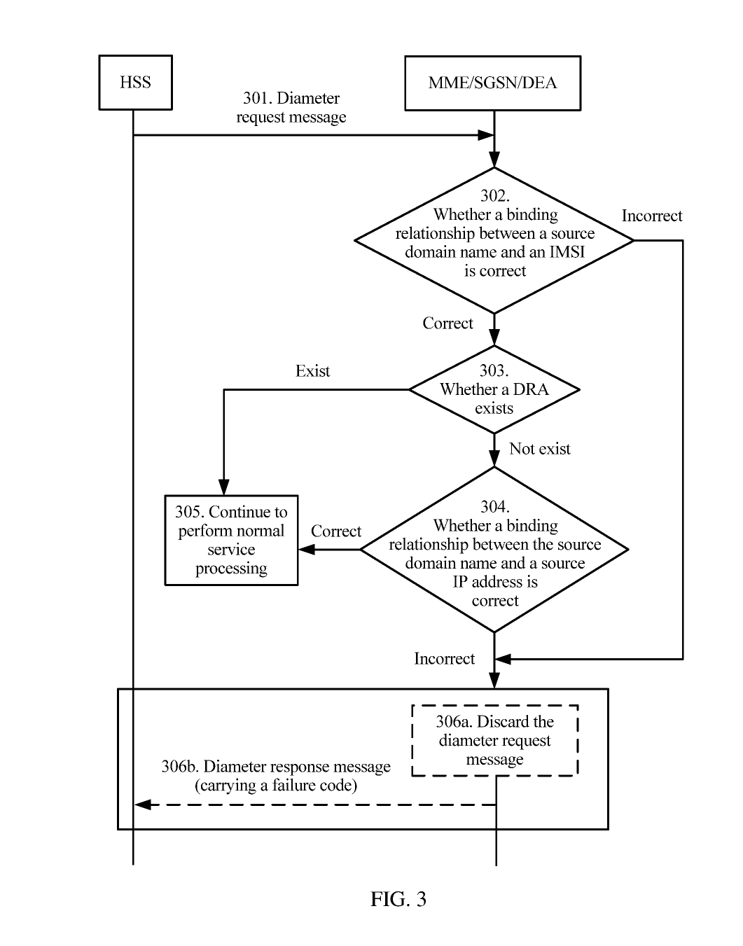

With reference to FIG. 3, the following describes in detail the method 200 for preventing a diameter signaling attack in a wireless network according to this embodiment of the present application. A method 300, shown in FIG. 3, for preventing a diameter signaling attack in a wireless network according to an embodiment of the present application is a specific example of the method 200.

301. An HSS sends a diameter request message, such as a cancel location request message, an insert subscriber data request message, a delete subscriber data request message, or a reset request message, to an MME or an SGSN or a DEA, where the diameter request message carries parameters such as a destination host name, a destination domain name, a source host name, a source domain name, and a user identity.

For the reset request message, the user identity carried is a user identity list (user ID list), and the user identity list includes one or more user identities. The user identity is an IMSI of a user.

302. The MME or the SGSN or the DEA determines whether a binding relationship between the source domain name and the user identity that are carried in the diameter request message is correct, and if the binding relationship is correct, performs step 303, or if the binding relationship is incorrect, performs step 306a or step 306b.

It should be noted that, for the reset request message, binding relationships between the source domain name carried in the diameter request message and all user identities in the user identity list need to be determined.

Optionally, the MME or the SGSN or the DEA determines a binding relationship between (the source domain name, the source host name) and the user identity that are carried in the diameter request message.

It should be noted that, step 303 is an optional step, that is, when determining that the binding relationship between the source domain name and the user identity that are carried in the diameter request message is correct, the MME or the SGSN or the DEA may directly perform step 305.

The MME or the SGSN or the DEA determines whether a DRA exists between the MME or the SGSN or the DEA and the HSS, and if the DRA does not exist, performs step 304, or if the DRA exists, performs step 305.

Specifically, if the received diameter request message carries a route record parameter, it is determined that the DRA exists between the MME or the SGSN or the DEA and the HSS; or if received diameter request message does not carry a route record parameter, it is determined that the DRA does not exist between the MME or the SGSN or the DEA and the HSS.

Optionally, when the DRA does not exist between the MME or the SGSN or the DEA and the HSS, step 305 may be further directly performed.

Optionally, when the DRA exists between the DEA and the HSS, the DEA may further perform the following operations:
(a) determining whether the source domain name is consistent with a domain name of the DEA; and
(b) if the source domain name is consistent with the domain name of the DEA, further determining whether a source IP address carried in the diameter request message belongs to an IP network segment of a network to which the DEA belongs; (b1) if the source IP address does not belong to the IP network segment of the network to which the DEA belongs, performing step 306a or step 306b; (b2) if the source IP address belongs to the IP network segment of the network to which the DEA belongs, sending the diameter request message to the MME or the SGSN for further processing, and performing, by the MME or the SGSN, step 305 after receiving the diameter request message.

Optionally, when the DRA exists between the DEA and the HSS or between the MME or the SGSN and the HSS, the following operations may be further performed:
(c) determining whether the source domain name is consistent with a domain name of the DEA; and
(d) if the source domain name is not consistent with the domain name of the DEA, sending, by the DEA, the diameter request message to the MME or the SGSN for further processing, and performing, by the MME or the SGSN, step 305 after receiving the diameter request message.

304. The MME or the SGSN or the DEA determines whether a binding relationship between the source domain name and/or the source host name and a source IP address that are carried in the diameter request message is correct, and if the binding relationship is correct, performs step 305, or if the binding relationship is incorrect, performs step 306a or step 306b.

305. The MME or the SGSN or the DEA continues to perform service processing.

That the MME or the SGSN continues to perform service processing means that the MME or the SGSN may further process the diameter request message according to a conventional processing procedure.

Optionally, if the diameter request message is a cancel location request, and a cancel type parameter carried in the cancel location request is an MME update procedure or an SGSN update procedure, the MME or the SGSN may further determine whether a context request message or an identification request message has been received before, and when the context request message or the identification request message has been received before, continue to perform service processing, or when the context request message or the identification request message has not been received before, perform step 306a or step 306b.

That the DEA continues to perform service processing means that the DEA sends the diameter request message to the MME or the SGSN for further processing.

306a. The MME or the SGSN or the DEA discards the diameter request message.

306b. The MME or the SGSN or the DEA sends a diameter response message to the HSS, where the diameter response message may be a cancel location response, an insert subscriber data response, a delete subscriber data response, or a reset response, where the diameter response message carries a failure code, the failure code may be carried in a result parameter, and the failure code may represent rejecting or not allowing continuing to process the diameter request message, or may be another failure code.

Either step 306a or step 306b is performed.

Optionally, in step 302 to step 305, it may be further determined whether (the destination domain name, the destination host name) carried in the diameter request message is consistent with (a domain name of the MME or the SGSN or the DEA, a host name of the MME or the SGSN or the DEA), and if (the destination domain name, the destination host name) carried in the diameter request message is consistent with (the domain name of the MME or the SGSN or the DEA, the host name of the MME or the SGSN or the DEA), subsequent processing continues, or if (the destination domain name, the destination host name) carried in the diameter request message is not consistent with (the domain name of the MME or the SGSN or the DEA, the host name of the MME or the SGSN or the DEA), step 306a or step 306b is performed.

In this embodiment of the present application, it is determined whether a binding relationship between a source domain name and a user identity that are carried in a diameter request message is correct, and if the binding relationship is incorrect, the diameter request message is discarded or a diameter response message carrying a failure code is sent, so that a diameter signaling attack can be prevented, and network security performance can be further improved.

It should be noted that, the example in FIG. 3 is intended to help a person skilled in the art better understand the embodiments of the present application, other than limiting the scope of the embodiments of the present application. Apparently, a person skilled in the art can perform various equivalent modifications or changes according to the example provided in FIG. 3, and such modifications or changes also fall within the scope of the embodiments of the present application.

It should be understood that, sequence numbers of the foregoing processes do not mean execution sequences. Execution sequences of the processes should be determined according to functions and internal logic of the processes, and shall not set any limitation on implementation processes of the embodiments of the present application.

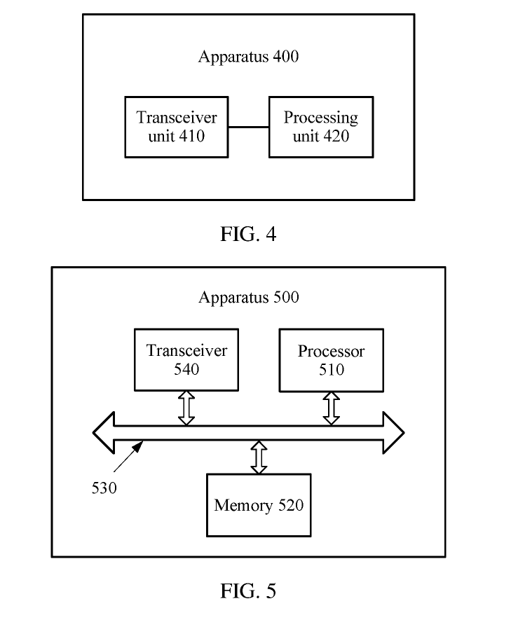

The method for preventing a diameter signaling attack in a wireless network according to the embodiments of the present application is described above in detail with reference to FIG. 2 and FIG. 3, and an apparatus for preventing a diameter signaling attack in a wireless network according to embodiments of the present application is described in the following in detail with reference to FIG. 4 and FIG. 5.

FIG. 4 is a schematic block diagram of an apparatus 400 for preventing a diameter signaling attack in a wireless network according to an embodiment of the present application. As shown in FIG. 4, the apparatus 400 includes a transceiver unit 410 and a processing unit 420.

The transceiver unit 410 is configured to receive a diameter request message sent by a home subscriber server HSS, where the diameter request message carries a source domain name and a user identity.

The processing unit 420 is configured to determine whether a first binding relationship between the source domain name and the user identity is correct.

The processing unit 420 is further configured to: if the first binding relationship is incorrect, discard the diameter request message; or the transceiver unit 410 is further configured to: if the first binding relationship is incorrect, send a diameter response message to the HSS, where the diameter response message carries a failure code.

The failure code may represent rejecting or not allowing continuing to process the diameter request message.

In this embodiment of the present application, it is determined whether a binding relationship between a source domain name and a user identity that are carried in a diameter request message is correct, and if the binding relationship is incorrect, the diameter request message is discarded, or a diameter response message carrying a failure code is sent. In this manner, a diameter signaling attack can be prevented, and network security performance can be further improved.

Optionally, the processing unit 420 is further configured to: if the first binding relationship is correct, continue to perform service processing.

Optionally, in another embodiment, the processing unit 420 is further configured to, if the first binding relationship is correct, determine, according to the diameter request message, whether a diameter relay agent DRA exists between the apparatus and the HSS, and if the DRA exists between the apparatus and the HSS, continue to perform service processing.

Optionally, in another embodiment, the diameter request message further carries a source IP address, and the processing unit 420 is further configured to: if the DRA does not exist between the apparatus and the HSS, determine whether a second binding relationship between the source IP address and the source domain name and/or a source host name is correct; and if the second binding relationship is correct, continue to perform service processing; or if the second binding relationship is incorrect, discard the diameter request message; or the transceiver unit 410 is further configured to: if the second binding relationship is incorrect, send a diameter response message to the HSS, where the diameter response message carries a failure code.

Optionally, in another embodiment, the processing unit 420 is further configured to: if the DRA does not exist between the apparatus and the HSS, continue to perform service processing.

Optionally, in another embodiment, the apparatus 400 is a diameter agent, the diameter request message further carries a source IP address, and the processing unit 420 is specifically configured to: if the DRA exists between the diameter agent and the HSS, determine whether the source domain name is consistent with a domain name of the diameter agent; if the source domain name is consistent with the domain name of the diameter agent, determine whether the source IP address belongs to an IP network segment of a network to which the diameter agent belongs; and if the source IP address belongs to the IP network segment, continue to perform service processing; or if the source IP address does not belong to the IP network segment, discard the diameter request message; or the transceiver unit 420 is further configured to: if the source IP address does not belong to the IP network segment, send a diameter response message to the HSS, where the diameter response message carries a failure code.

Optionally, in another embodiment, the processing unit 420 is specifically configured to, if the diameter request message does not carry a route record parameter, determine that the DRA does not exist between the apparatus and the HSS, or if the diameter request message carries a route record parameter, determine that the DRA exists between the apparatus and the HSS.

The diameter request message may be any one of the following: a cancel location request message, an insert subscriber data request message, a delete subscriber data request message, or a reset request message.

Correspondingly, the diameter response message may be any one of the following: a cancel location response message, an insert subscriber data response message, a delete subscriber data response message, or a reset response message

Optionally, in another embodiment, if the diameter request message is a cancel location request message, and a cancel type parameter carried in the cancel location request message represents an MME update process or an SGSN update process, the processing unit 420 is specifically configured to: determine whether a context request message or an identification request message is received; and when the context request message or the identification request message is not received, discard the diameter request message; the transceiver unit 410 is further configured to send a diameter response message to the HSS when the context request message or the identification request message is not received, where the diameter response message carries a failure code; the processing unit 420 is specifically configured to: when the context request message or the identification request message is received, continue to perform service processing.

Optionally, when the diameter request message is a reset request message, the user identity is a user identity list, and the processing unit 420 is specifically configured to determine whether first binding relationships between the source domain name and all user identities in the user identity list are correct. The user identity list includes at least one user identity.

It should be understood that, the apparatus 400 according to this embodiment of the present application may correspond to the MME or the SGSN or the diameter agent in the method 200 for preventing a diameter signaling attack in a wireless network according to the embodiment of the present application, and the foregoing and other operations and/or functions of the units or modules of the apparatus 400 are respectively used to implement the corresponding procedures of the method 200 and the method 300 in FIG. 2 and FIG. 3. For brevity, details are not repeatedly described herein.

In this embodiment of the present application, it is determined whether a binding relationship between a source domain name and a user identity that are carried in a diameter request message is correct. If the binding relationship is incorrect, the diameter request message is discarded or a diameter response message carrying a failure code is sent, so that a diameter signaling attack can be prevented, and network security performance can be further improved.

FIG. 5 is a schematic block diagram of an apparatus 500 that has a function of preventing a diameter signaling attack in a wireless network according to an embodiment of the present application. The apparatus 500 may be an MME or an SGSN or a diameter agent. As shown in FIG. 5, the apparatus 500 includes a processor 510, a memory 520, a bus system 530, and a transceiver 540. The processor 510, the memory 520, and the transceiver 540 are connected by using the bus system 530, the memory 520 is configured to store an instruction, and the processor 510 is configured to execute the instruction stored in the memory 520.

The transceiver 540 is configured to receive a diameter request message sent by a home subscriber server HSS, where the diameter request message carries a source domain name and a user identity.

The processor 510 is configured to determine whether a first binding relationship between the source domain name and the user identity is correct.

The processor 510 is further configured to, if the first binding relationship is incorrect, discard the diameter request message. The transceiver 540 is further configured to, if the processor 510 determines that the first binding relationship is incorrect, send a diameter response message to the HSS, where the diameter response message carries a failure code.

The failure code may represent rejecting or not allowing continuing to process the diameter request message.

In this embodiment of the present application, it is determined whether a binding relationship between a source domain name and a user identity that are carried in a diameter request message is correct. If the binding relationship is incorrect, the diameter request message is discarded or a diameter response message carrying a failure code is sent, so that a diameter signaling attack can be prevented, and network security performance can be further improved.

It should be understood that, in this embodiment of the present application, the processor 510 may be a central processing unit (CPU), or the processor 510 may be another general purpose processor, a digital signal processor (DSP), an Application Specific Integrated Circuit (ASIC), a Field-Programmable Gate Array (FPGA) or another programmable logic device, a discrete gate or a transistor logic device, a discrete hardware component, or the like. The general purpose processor may be a microprocessor or the processor 510 may be any conventional processor, or the like.

The memory 520 may include a read-only memory and a random access memory, and provides an instruction and data for the processor 510. A part of the memory 520 may further include a nonvolatile random access memory. For example, the memory 520 may further store information about a device type.

In addition to a data bus, the bus system 530 may include a power bus, a control bus, a status signal bus, and the like. However, for clear description, various types of buses in the figure are marked as the bus system 530.

In an implementation process, the steps of the foregoing method may be completed by means of an integrated logic circuit of hardware in the processor 510 or an instruction in a form of software. The steps of the method disclosed with reference to the embodiments of the present application may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 520. The processor 510 reads information in the memory 520, and completes the steps of the foregoing method in combination with hardware in the processor 510. To avoid repetition, details are not repeatedly described herein.

Optionally, the processor 510 is further configured to: if the first binding relationship is correct, continue to perform service processing.

Optionally, in another embodiment, the processor 510 is further configured to, if the first binding relationship is correct, determine, according to the diameter request message, whether a diameter relay agent DRA exists between the apparatus and the HSS. If the DRA exists between the apparatus and the HSS, the processor 510 is further configured to continue to perform service processing.

Optionally, in another embodiment, the diameter request message further carries a source IP address, and the processor 510 is further configured to: if the DRA does not exist between the apparatus and the HSS, determine whether a second binding relationship between the source IP address and the source domain name and/or a source host name is correct. If the second binding relationship is correct, the processor 510 is further configured to continue to perform service processing, or if the second binding relationship is incorrect, the processor 510 is further configured to discard the diameter request message. The transceiver 540 is further configured to: if the processor 510 determines that the second binding relationship is incorrect, send a diameter response message to the HSS, where the diameter response message carries a failure code.

Optionally, in another embodiment, the processor 510 is further configured to: if the DRA does not exist between the apparatus and the HSS, continue to perform service processing.

Optionally, in another embodiment, the apparatus 500 is a diameter agent, the diameter request message further carries a source IP address, and the processor 510 is specifically configured to: if the DRA exists between the diameter agent and the HSS, determine whether the source domain name is consistent with a domain name of the diameter agent. If the source domain name is consistent with the domain name of the diameter agent, the processor 510 is further configured to determine whether the source IP address belongs to an IP network segment of a network to which the diameter agent belongs. If the source IP address belongs to the IP network segment, the processor 510 is further configured to continue to perform service processing, or if the source IP address does not belong to the IP network segment, the processor 510 is further configured to discard the diameter request message. The transceiver 540 is further configured to, if the processor 510 determines that the source IP address does not belong to the IP network segment, send a diameter response message to the HSS, where the diameter response message carries a failure code.

Optionally, in another embodiment, the processor 510 is specifically configured to: if the diameter request message does not carry a route record parameter, determine that the DRA does not exist between the apparatus and the HSS; or if the diameter request message carries a route record parameter, determine that the DRA exists between the apparatus and the HSS.

The diameter request message may be any one of the following: a cancel location request message, an insert subscriber data request message, a delete subscriber data request message, or a reset request message.

Correspondingly, the diameter response message may be any one of the following: a cancel location response message, an insert subscriber data response message, a delete subscriber data response message, or a reset response message

Optionally, in another embodiment, if the diameter request message is a cancel location request message, and a cancel type parameter carried in the cancel location request message represents a mobile management entity MME update process or a serving general packet radio service support node SGSN update process, the processor 510 is specifically configured to: determine whether a context request message or an identification request message is received; and when the context request message or the identification request message is received, continue to perform service processing; or when the context request message or the identification request message is not received, discard the diameter request message; or the transceiver 540 is further configured to: when the processor 510 determines that the context request message or the identification request message is not received, send a diameter response message to the HSS, where the diameter response message carries a failure code.

Optionally, when the diameter request message is a reset request message, the user identity is a user identity list, and the processor 510 is specifically configured to determine whether first binding relationships between the source domain name and all user identities in the user identity list are correct. The user identity list includes at least one user identity.

It should be understood that, the apparatus 500 according to this embodiment of the present application may be corresponding to the MME or the SGSN or the diameter agent in the method 200 for preventing a diameter signaling attack in a wireless network according to the embodiment of the present application or the apparatus 400 for preventing a diameter signaling attack in a wireless network according to the embodiment of the present application, and the foregoing and other operations and/or functions of the units or modules of the apparatus 500 are respectively used to implement the corresponding procedures of the method 200 and the method 300 in FIG. 2 and FIG. 3. For brevity, details are not repeatedly described herein.

In this embodiment of the present application, it is determined whether a binding relationship between a source domain name and a user identity that are carried in a diameter request message is correct, and if the binding relationship is incorrect, the diameter request message is discarded or a diameter response message carrying a failure code is sent, so that a diameter signaling attack can be prevented, and network security performance can be further improved.

An embodiment of the present application further provides a system for preventing a diameter signaling attack in a wireless system, and the system includes an MME or an SGSN or a diameter agent and a home subscriber server HSS.

The HSS is configured to send a diameter request message to the MME or the SGSN or the diameter agent, where the diameter request message carries a source domain name and a user identity.

The MME or the SGSN or the diameter agent is configured to: receive the diameter request message; determine whether a first binding relationship between the source domain name and the user identity that are carried in the diameter request message is correct; and if the first binding relationship is incorrect, discard the diameter request message or send a diameter response message to the HSS, where the diameter response message carries a failure code.

In this embodiment of the present application, an MME or an SGSN or a diameter agent determines whether a binding relationship between a source domain name and a user identity that are carried in a diameter request message sent by an HSS is correct, and if the binding relationship is incorrect, discards the diameter request message or sends a diameter response message carrying a failure code, so that a diameter signaling attack can be prevented, and network security performance can be further improved.

It should be understood that, the MME or the SGSN or the diameter agent in the system according to this embodiment of the present application may correspond to the MME or the SGSN or the diameter agent in the method 200 for preventing a diameter signaling attack in a wireless network according to the embodiment of the present application, the apparatus 400 for preventing a diameter signaling attack in a wireless network according to the embodiment of the present application, and the apparatus 500 for preventing a diameter signaling attack in a wireless network according to the embodiment of the present application. For brevity, details are not repeatedly described herein.

It should be understood that, the term “and/or” in this embodiment of the present application describes only an association relationship for describing associated objects and represents that three relationships may exist. For example, A and/or B may represent the following three cases: Only A exists, both A and B exist, and only B exists. In addition, the character “/” generally indicates an “or” relationship between the associated objects.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in an actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual requirements to achieve the objectives of the solutions of the embodiments.

In addition, functional units in the embodiments of the present application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present application essentially, or the part contributing to the prior aft, or some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of the present application. The storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method, comprising:
receiving, by a device, a diameter request message sent by a home subscriber server (HSS), wherein the diameter request message carries a source domain name and a user identity, and wherein the device is a mobile management entity (MME), a serving general packet radio service support node (SGSN), or a diameter agent;
determining, by the device, whether a first binding relationship between the source domain name and the user identity is correct; and
when the first binding relationship is incorrect, discarding the diameter request message, or sending a first diameter response message to the HSS, the first diameter response message carrying a first failure code.

2. The method according to claim 1, further comprising:
when the first binding relationship is correct, determining, according to the diameter request message, whether a diameter relay agent (DRA) exists between the device and the HSS; and
when the DRA exists between the device and the HSS, continuing to perform service processing.

3. The method according to claim 2, wherein the diameter request message further carries a source IP address, and the method further comprises:
when the DRA does not exist between the device and the HSS, determining whether a second binding relationship between two or more of the source IP address, the source domain name, or a source host name, is correct;
when the second binding relationship is incorrect, discarding the diameter request message, or sending a second diameter response message to the HSS, wherein the second diameter response message carries a second failure code; and
when the second binding relationship is correct, continuing to perform service processing.

4. The method according to claim 2, further comprising:
when the DRA does not exist between the device and the HSS, continuing to perform service processing.

5. The method according to claim 2, wherein the diameter request message further carries a source IP address, and when the DRA exists between the diameter agent and the HSS, the continuing to perform service processing comprises:
when the DRA exists between the diameter agent and the HSS, determining whether the source domain name is consistent with a domain name of the diameter agent;
when the source domain name is consistent with the domain name of the diameter agent, determining whether the source IP address belongs to an IP network segment of a network to which the diameter agent belongs;
when the source IP address does not belong to the IP network segment, discarding the diameter request message or sending a third diameter response message to the HSS, wherein the third diameter response message carries a third failure code, or continuing to perform service processing.

6. The method according to claim 2, wherein determining, according to the diameter request message, whether the DRA exists between the device and the HSS comprises:
when the diameter request message does not carry a route record parameter, determining that the DRA does not exist between the device and the HSS; and
when the diameter request message carries a route record parameter, determining that the DRA exists between the device and the HSS.

7. The method according to claim 2, wherein the diameter request message is a cancel location request message, and a cancel type parameter carried in the cancel location request message represents an MME update process or an SGSN update process, and the device continuing to perform service processing comprises:
determining whether a context request message or an identification request message is received;
when the context request message or the identification request message is not received, discarding the diameter request message, or sending a fourth diameter response message to the HSS, the fourth diameter response message carrying a fourth failure code; and
when the context request message or the identification request message is received, continuing to perform service processing.

8. The method according to claim 1, wherein the first failure code indicates that continuing to process the diameter request message is rejected or not allowed.

9. The method according to claim 1, wherein the diameter request message is a cancel location request message, an insert subscriber data request message, a delete subscriber data request message, or a reset request message.

10. The method according to claim 1, wherein the first diameter response message is a cancel location response message, an insert subscriber data response message, a delete subscriber data response message, or a reset response message.

11. The method according to claim 1, wherein the diameter request message is a reset request message, the user identity is a user identity list, and determining whether the first binding relationship between the source domain name and the user identity is correct comprises:
determining whether a plurality of first binding relationships between the source domain name and a plurality of user identities in the user identity list are correct.

12. An apparatus, comprising:
a transceiver, configured to receive a diameter request message sent by a home subscriber server (HSS), wherein the diameter request message carries a source domain name and a user identity;
a processor; and
a computer-readable storage medium storing a program to be executed by the processor, the program including instructions for:
determining whether a first binding relationship between the source domain name and the user identity is correct; and
when the first binding relationship is incorrect, discarding the diameter request message; and
when the first binding relationship is incorrect, sending a first diameter response message to the transceiver to send to the HSS, wherein the first diameter response message carries a first failure code.

13. The apparatus according to claim 12, wherein the program further includes instructions for:
when the first binding relationship is correct, determining, according to the diameter request message, whether a diameter relay agent (DRA) exists between the apparatus and the HSS; and
when the DRA exists between the apparatus and the HSS, continuing to perform service processing.

14. The apparatus according to claim 13, wherein the diameter request message further carries a source IP address, and the program further includes instructions for:
when the DRA does not exist between the apparatus and the HSS, determining whether a second binding relationship between two or more of the source IP address, the source domain name, or a source host name, is correct;
when the second binding relationship is correct, continuing to perform service processing; and
when the second binding relationship is incorrect, discarding the diameter request message, or when the second binding relationship is incorrect, sending a second diameter response message to the transceiver to send to the HSS, wherein the second diameter response message carries a second failure code.

15. The apparatus according to claim 13, wherein the program further includes instructions for, when the DRA does not exist between the apparatus and the HSS, continuing to perform service processing.

16. The apparatus according to claim 13, wherein the apparatus is a diameter agent, the diameter request message further carries a source IP address, and the program further includes instructions for:
when the DRA exists between the diameter agent and the HSS, determining whether the source domain name is consistent with a domain name of the diameter agent;
when the source domain name is consistent with the domain name of the diameter agent, determining whether the source IP address belongs to an IP network segment of a network to which the diameter agent belongs;
when the source IP address belongs to the IP network segment, continuing to perform service processing;
when the source IP address does not belong to the IP network segment, discarding the diameter request message, or sending a third diameter response message to the transceiver to send to the HSS, wherein the third diameter response message carries a failure code.

17. The apparatus according to claim 13, wherein the program further includes instructions for:
when the diameter request message does not carry a route record parameter, determining that the DRA does not exist between the apparatus and the HSS; and
when the diameter request message carries a route record parameter, determining that the DRA exists between the apparatus and the HSS.

18. The apparatus according to claim 12, wherein the first failure code indicates that continuing to process the diameter request message is rejected or not allowed.

19. The apparatus according to claim 12, wherein the diameter request message is a cancel location request message, an insert subscriber data request message, a delete subscriber data request message, or a reset request message.

20. The apparatus according to claim 12, wherein the first diameter response message is a cancel location response message, an insert subscriber data response message, a delete subscriber data response message, or a reset response message.
